(19) United States
(12) Patent Application Publication
(10) Pub. No.: US 2026/0204779 A1
(43) Pub. Date: Jul. 16, 2026

(54) BASE STATION ANTENNAS WITH INTEGRATED SENSORS

(71) Applicant: Outdoor Wireless Networks LLC, Richardson, TX (US)

(72) Inventor: Björn Lindmark, Sollentuna (SE)

(21) Appl. No.: 19/444,595

(22) Filed: Jan. 9, 2026

Related U.S. Application Data
(60) Provisional application No. 63/744,423, filed on Jan. 13, 2025.

(51) Int. Cl. H01Q 3/26; H01Q 1/24; H01Q 5/22

(52) U.S. Cl. CPC H01Q 3/2617; H01Q 1/246; H01Q 5/22

(57) ABSTRACT

The present disclosure is directed to a base station antenna assembly. The base station antenna assembly includes a base station antenna including an external housing having a plurality of connectors extending outwardly therefrom and one or more integrated sensors residing inside of the external housing of the base station antenna. Each of the integrated sensors are coupled to a respective connector of the plurality of connectors via one or more cables, the one or more cables being routed inside of the external housing of the base station antenna.

### RELATED APPLICATION(S)

The present application claims priority to and the benefit of U.S. Provisional Patent Application Serial No. 63/744,423, filed January 13, 2025, the disclosures of which are incorporated herein by reference in full.

### FIELD

The present invention generally relates to radio communications and, more particularly, to base station antennas for cellular communications systems.

### BACKGROUND

Cellular communications systems are well known in the art. In a cellular communications system, a geographic area is divided into a series of regions that are referred to as "cells" which are served by respective base stations. The base station may include one or more antennas that are configured to provide two-way radio frequency ("RF") communications with mobile subscribers that are within the cell served by the base station.

In many cases, each cell is divided into "sectors." A common base station configuration is the three-sector configuration in which a cell is divided into three 120º sectors in the azimuth (horizontal) plane. One or more base station antennas provide coverage (service) to each sector with the base station antennas having an azimuth Half Power Beamwidth (HPBW) of approximately 65°. Typically, the base station antennas are mounted on a tower or other raised structure, with the radiation patterns (also referred to herein as "antenna beams") that are generated by the base station antennas directed outwardly.

Base station antennas are often implemented as linear or planar phased arrays of radiating elements. Typically, each base station antenna will include multiple vertically-extending columns of radiating elements that operate, for example, using second generation ("2G"), third generation ("3G") or fourth generation ("4G") cellular network protocols. These vertically-extending columns of radiating elements are typically referred to as "linear arrays," and may be straight columns of radiating elements or columns in which some of the radiating elements are staggered horizontally. Most modern base station antennas include both "low-band" linear arrays of radiating elements that support service in some or all of the 617-960 MHz frequency band and "mid-band" linear arrays of radiating elements that support service in some or all of the 1427-2690 MHz frequency band. These linear arrays are typically formed using dual-polarized radiating elements, which allows each array to transmit and receive RF signals at two orthogonal polarizations.

Each of the above-described linear arrays is coupled to two ports of a radio (one port for each polarization). An RF signal that is to be transmitted by a linear array is passed from the radio to the base station antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Typically these linear arrays will have remote electronic tilt ("RET") capabilities which allow a cellular operator to change the pointing angle of the generated antenna beams in the elevation (vertical) plane in order to change the size of the sector served by the linear array. Since the antenna beams generated by the above-described 2G/3G/4G linear arrays generate static antenna beams, they are often referred to as "passive" linear arrays.

Most cellular operators are currently upgrading their networks to support fifth generation ("5G") cellular service. In order to increase capacity without further increasing the number of base station antennas, multi-band base station antennas have been introduced which include multiple linear arrays of radiating elements. One important component of 5G cellular service is the use of so-called multi-column "active" beamforming arrays that operate in conjunction with beamforming radios to dynamically adjust the size, shape and pointing direction of the antenna beams that are generated by the active beamforming array. The radios for these beamforming arrays may be integrated into the antenna so that the antenna may perform active beamforming (i.e., the shapes of the antenna beams generated by the antenna may be adaptively changed to improve the performance of the antenna). These active beamforming arrays are typically formed using "high-band" radiating elements that operate in higher frequency bands, such as some or all of the 3.3-4.2 GHz and/or the 5.1-5.8 GHz frequency bands. Each column of such an active beamforming array is typically coupled to a respective port of a beamforming radio.

The beamforming radio may be a separate device, or may be integrated with the active antenna array. Antennas having integrated radios that can adjust the amplitude and/or phase of the sub-components of an RF signal that are transmitted through individual radiating elements or small groups thereof are referred to as "active antennas." Active antennas can generate narrowed beamwidth, high gain, antenna beams and can steer the generated antenna beams in different directions. The beamforming radio may adjust the amplitudes and phases of the sub-components of an RF signal that are fed to each port of the radio in order to generate antenna beams that have narrowed beamwidths in the azimuth plane and/or elevation plane (and hence higher antenna gain). These narrowed antenna beams can be electronically steered by proper selection of the amplitudes and phases of the sub-components of an RF signal.

With the development of wireless communication technology, an integrated base station antenna including a "passive" module and an "active" antenna module with an active antenna has emerged. The passive module may include one or more passive arrays of radiating elements that are configured to generate relatively static antenna beams, such as antenna beams that are configured to cover the 120° sector (in the azimuth plane) of a base station antenna. The passive arrays may comprise arrays that operate under second generation (2G), third generation (3G) or fourth generation (4G) cellular standards. These passive arrays are not configured to perform active beamforming operations, although they typically have remote electronic tilt (RET) capabilities which allows the shape of the antenna beam to be changed via electromechanical means in order to change the coverage area of the antenna beam. The active antenna module may include one or more arrays of radiating elements that operate under fifth generation (5G) (or later) cellular standards. These arrays typically have individual amplitude and phase control over subsets of the radiating elements therein and perform active beamforming.

In order to avoid having to increase the number of antennas at cell sites, the above-described 5G antennas also often include passive linear arrays that support legacy 2G, 3G and/or 4G cellular services. In some cases, both the active beamforming arrays and the passive linear arrays may be included in a single base station antenna. Another solution for providing an antenna that supports both 2G/3G/4G and 5G cellular service is to mount a 5G active antenna module (i.e., a module that includes an active beamforming array and associated beamforming radio) on the rear surface of a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. This design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a "passive/active antenna system." Base station antennas that include active antenna units with a radio and a multi-input-multi-output (mMIMO) array of radiating elements that reside behind a rear of the base station antenna have also been disclosed. See, U.S. Patent Number 11,482,774, the contents of which are also hereby incorporated by reference as if recited in full herein.

### SUMMARY

Embodiments of the present invention are directed to a base station antenna assembly. The base station antenna assembly includes a base station antenna including an external housing having a plurality of connectors extending outwardly therefrom and one or more integrated sensors residing inside of the external housing of the base station antenna. Each of the integrated sensors are coupled to a respective connector of the plurality of connectors via one or more cables, the one or more cables being routed inside of the external housing of the base station antenna.

Further embodiments of the present invention are directed to a base station antenna assembly. The base station antenna assembly includes a base station antenna having an external housing, an active antenna module including a multi-input-multi-output (mMIMO) beamforming antenna array, and one or more integrated sensors residing inside of the external housing of the base station antenna. At least one of the integrated sensors is an imaging device.

Further embodiments of the present invention are directed to a base station antenna assembly. The base station antenna assembly includes a passive/active antenna system. The passive/active antenna system includes a passive base station antenna having an external housing and an active antenna module including a multi-input-multi-output (mMIMO) beamforming antenna array. The base station antenna assembly further includes one or more integrated sensors residing inside of the external housing of the passive base station antenna. At least one of the integrated sensors is an imaging device.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 and FIG. 2 are schematic perspective views of prior art base station antennas.

FIG. 3A is a schematic rear perspective view of a prior art passive/active antenna system.

FIG. 3B is a schematic perspective view of theactive antenna module for the passive/active antenna system shown in FIG. 3A.

FIG. 3C is a schematic perspective view of the passive/active antenna system shown in FIG. 3A with the radome of the passive base station antenna removed.

FIG. 4 is a schematic side view of another prior art base station antenna.

FIG. 5 is a schematic side view of a base station antenna assembly according to embodiments of the present invention.

FIG. 6 is a schematic side view of another base station antenna assembly according to embodiments of the present invention.

FIG. 7 is a schematic side view of another base station antenna assembly according to embodiments of the present invention.

FIGS. 8A-8B illustrate example applications for which the base station antenna assemblies shown in FIG. 6 and FIG. 7, respectively, may be used.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10', 10'', 10''').

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising", when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items.

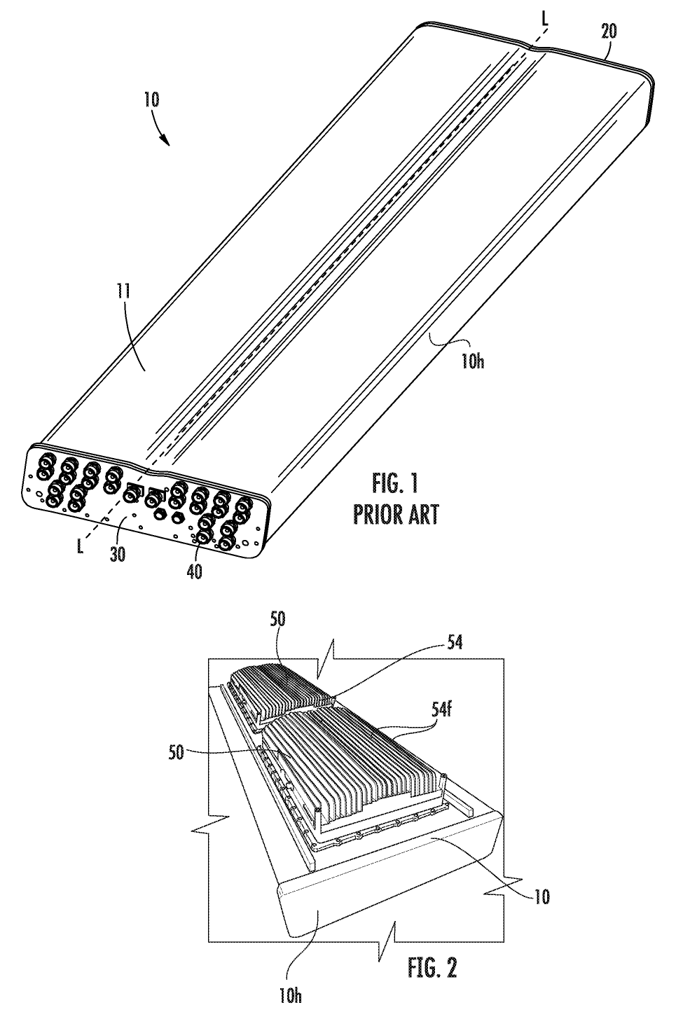

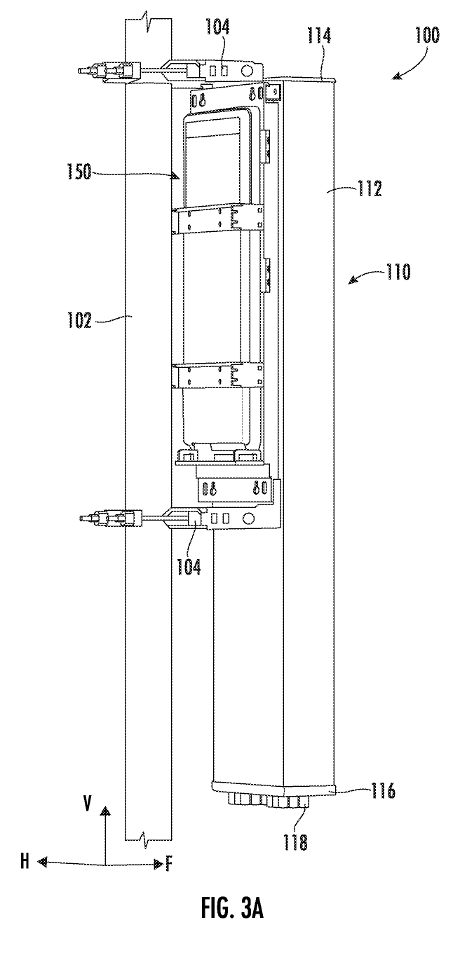

FIG. 1 and FIG. 2 illustrate an example of a prior known base station antenna 10. In some instances, the base station antenna 10 may include a pair of beamforming arrays and associated beamforming radios. The base station antenna 10 is typically mounted with the longitudinal axis L of the antenna 10 extending along a vertical axis (e.g., the longitudinal axis L may be generally perpendicular to a plane defined by the horizon) when the antenna 10 is mounted for normal operation. The front surface of the antenna 10 is mounted opposite the tower or other mounting structure, pointing toward the coverage area for the antenna 10. Typically, the antenna 10 includes a radome 11 and an upper end cap 20. A "radome" refers to a dielectric cover that allows RF energy to pass through in certain frequency bands. At least part of the radome 12 may be formed of, for example, fiberglass or plastic. The antenna 10 also includes a lower end cap 30 which includes a plurality of connectors 40 mounted therein. As shown in FIG. 1, the radome 11, upper end cap 20 and lower end cap 30 define an external housing 10h for the antenna 10. An antenna assembly is contained within the housing 10h (i.e., within an internal cavity) of the base station antenna 10.

FIG. 2 illustrates that the base station antenna 10 can include one or more radios 50 that are mounted to the external housing 10h. Further details of example base station antennas can be found in International PCT Publication Nos. WO2019/236203 and WO2020/072880, the contents of which are hereby incorporated by reference as if recited in full herein.

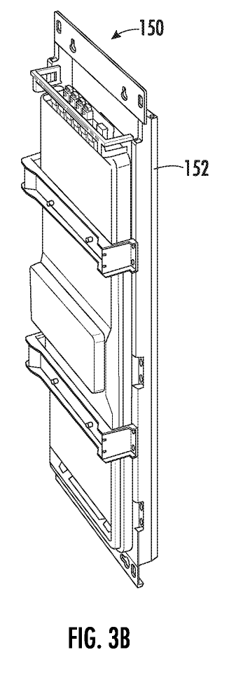

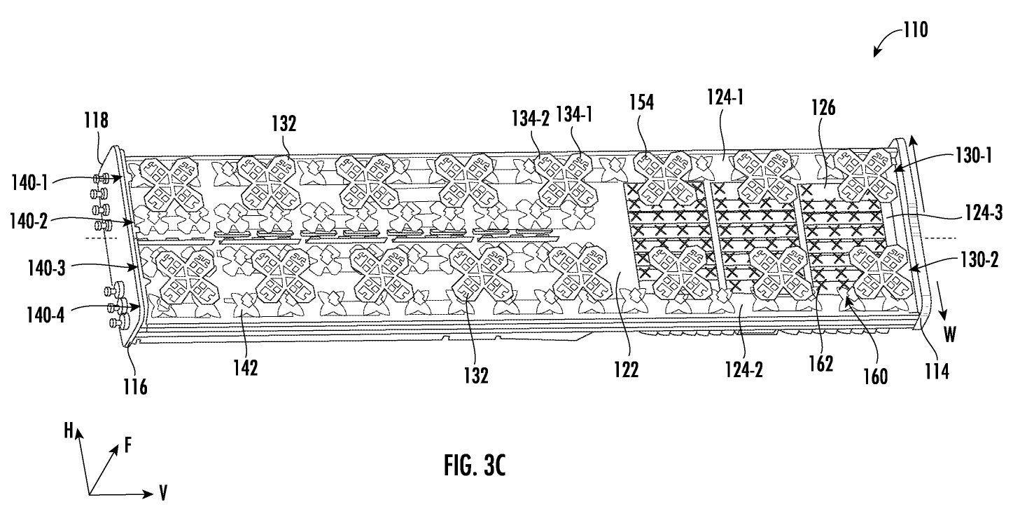

FIGS. 3A-3C illustrate an example of a prior known passive/active antenna system 100. The passive/active antenna system 100 shown in FIGS. 3A-3C includes both a passive base station antenna and an active antenna module. FIG. 3A is a schematic rear perspective view of a passive/active antenna system 100. FIG. 3B is a perspective view of theactive antenna module 150 for the passive/active antenna system 100 shown in FIG. 3A. FIG. 3C is a schematic perspective view of the passive/active antenna system 100 of FIG. 3A with the radome 112 of the passive base station antenna 110 removed. In FIGS. 3A and 3C, the axes illustrate the vertical (V), horizontal (H) and forward (F) directions of the illustrated passive/active antenna system 100.

Referring to FIG. 3A, the passive/active antenna system 100 may be mounted, for example, on an antenna tower 102 using mounting hardware 104. The passive/active antenna system 100 includes a passive base station antenna 110 and an active antenna module 150 that is mounted behind the passive base station antenna 110. The active antenna module 150 may be mounted directly on a rear surface of the passive base station antenna 110, or may be held in place behind the passive base station antenna 110. For example, the mounting hardware 104 that is used to mount the passive/active antenna system 100 on the antenna tower 102 (or other structure) may be used to hold the active antenna module 150 in place behind the passive base station antenna 100. The front surface of the passive/active antenna system 100 may be opposite the antenna tower 102 facing toward a coverage area of the passive/active antenna system 100. The passive base station antenna 110 includes a radome 112 that surrounds and protects an antenna assembly that is mounted inside the radome 112. An upper end cap 114 covers an upper opening in the radome 112 and a lower end cap 116 covers a lower opening in the radome 112 to define an internal cavity of the passive/active antenna system 100. A plurality of RF ports 118 extend through the lower end cap 116 and are used to connect the passive base station antenna 110 to one or more external radios (not shown). The active antenna module 150 may be removably mounted behind the passive base station antenna 110 so that the active antenna module 150 may later be replaced with a different active antenna module, preferably without removing the passive base station antenna 110 from the antenna tower 102.

Referring to FIG. 3C, the passive base station antenna 110 includes a reflector assembly 114 and a plurality of passive linear arrays of radiating elements that extend forwardly from the reflector assembly 114. The reflector assembly 114 may be referred to herein as a "passive reflector assembly" since it is part of the passive base station antenna 110. The linear arrays may support, for example, 3G and/or 4G cellular service. As used herein, the term "passive reflector assembly" or "passive antenna assembly" refers to an antenna assembly having arrays of radiating elements that are coupled to radios that are external to the antenna, typically remote radio heads that are mounted in close proximity to the base station antenna 10, 110 (or external housing 10h). The arrays of radiating elements included in the passive base station antenna 110 are configured to form static antenna beams (e.g., antenna beams that are each configured to cover a sector of a base station). The passive reflector assembly 114 can comprise radiating elements such as one or both low-band radiating elements 132 and/or mid-band or high band radiating elements 142. The passive reflector assembly 114 is mounted in the base station antenna housing 10h and the base station antenna housing 10h can releasably (detachably) couple (e.g., directly or indirectly attach) to one or more active antenna modules 150 that is/are separate from the passive base station antenna 110.

In the example passive base station antenna 110 shown in FIG. 3A and FIG. 3C, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station antenna 110), with the only change to the coverage area occurring when the electronic downtilt or uptilt angles of the generated antenna beams are adjusted (e.g., to change the size of the cell).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in the array, and the second RF port 118 is connected between a second port of a radio and the second polarization radiators of the radiating elements in the array. RF signals that are to be transmitted by a selected one of the linear arrays 130, 140 are passed from the radio to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components are radiated into free space.

As further shown in FIG. 3C, the passive reflector assembly 114 includes a main reflector 122 and spaced-apart first and second reflector strips 124-1, 124-2 that extend vertically from respective first and second opposed sides of the main reflector 122. The passive reflector assembly 120 may further include a third reflector strip 124-3 that extends in the horizontal direction between the first and second reflector strips 124-1, 124-2. An opening 126 is defined between the first and second reflector strips 124-1, 124-2. For example, the opening 126 may be bounded by an upper portion of the main reflector 122, the first and second reflector strips 124-1, 124-2, and the third reflector strip 124-3. Most of the low-band and mid-band radiating elements 132, 142 are mounted to extend forwardly from the main reflector 122. However, low-band linear arrays 130-1, 130-2 and mid-band linear arrays 140-2, 140-3 each extend substantially the full length of the passive/active antenna system 100 and hence extend beyond the main reflector 122. The first and second reflector strips 124-1, 124-2 provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may be important for the performance of the linear arrays 130-1, 130-2, 140-2, 140-3.

Each low-band radiating element 132 may comprise a slant -45⁰/+45⁰ cross-dipole radiating element that includes a -45⁰ dipole radiator 134-1 and a +45⁰ dipole radiator 134-2 that are arranged to form a cross when the radiating element 132 is viewed from the front. The dipole radiators 134 may (but need not) extend in a plane that is parallel to a plane defined by the main reflector 122. The dipole radiators 134-1, 134-2 may be mounted on a feed stalk of the radiating element 132. Conventionally, cross-dipole radiating elements extend forwardly from a main reflector surface of a reflector assembly with the feed stalks the radiating elements extending perpendicularly to the main reflector surface. The feed stalk may be configured to pass RF signals between the dipole radiators and an associated feed network, and may also be used to support the dipole radiators forwardly of the reflector assembly. The radiating elements 132 that extend forwardly from the main reflector 122 may have a conventional design where the feed stalks extend perpendicularly to the main reflector 122.

Referring to FIG. 3B and FIG. 3C, the active antenna module 150 includes a multi-column beamforming array 160 of radiating elements 162 and a beamforming radio (not visible in the figures). The multi-column beamforming array 160 may be mounted in a forward portion of a radome 152 of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band. The high-band radiating elements 162 are mounted to extend forwardly from a reflector 154 of the active antenna module 150.

As used herein, the term "active antenna module" is used interchangeably with "active antenna unit," "AAU," "remote radio unit" or "radio" and refers to a cellular communications unit comprising radio circuitry and associated antenna elements that are capable of electronically adjusting the amplitude and/or phase of the subcomponents of an RF signal that are output to different radiating elements of an array or groups thereof. In some embodiments, the active antenna module 150 comprises the radio circuitry and the radiating elements (e.g., a multi-input-multi-output (mMIMO) beamforming antenna array) and may include other components such as filters, a calibration network, antenna interface signal group (AISG) controller and the like. The active antenna module 150 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front-to-back direction of the base station antenna 10, 110, with the antenna unit closer to a front (i.e., radome 12, 112) of the base station antenna 10, 110 than the radio unit.

The beamforming radio is capable of electronically adjusting the amplitudes and/or phases of the subcomponents of an RF signal that are output to different radiating elements 162 of the multi-column beamforming array 160. For example, each port of the beamforming radio may be coupled to a column of radiators of the beamforming array 160, and the amplitudes and phases of the sub-components of the RF signal that are fed to the radiators in each column may be adjusted so that the generated antenna beam is narrowed in the azimuth plane and pointed in a desired direction in the azimuth plane. The active antenna module 150 may further include other components such as filters, a calibration network, an antenna interface signal group (AISG) controller and the like.

As is shown in FIG. 3C, the beamforming array 160 of active antenna module 150 is mounted behind the opening 126 in the passive reflector assembly 114. The beamforming array 160 is visible in FIG. 3C as the radomes 112, 152 of both the passive base station antenna 110 and the active antenna module 150 are removed in the view of FIG. 3C. The opening 126 in the passive reflector assembly 114 allows the antenna beams generated by the beamforming array 160 to pass through the passive base station antenna 110 and out of the front of the radome 112 of the passive base station antenna 110 to provide service to the coverage area of the passive/active antenna system 100.

In some embodiments, the passive/active antenna system 100 may be designed so that a variety of different active antenna modules 150 can be used in a given passive base station antenna 110. The active antenna module 150 can be manufactured by any original equipment manufacturer and/or cellular service provider and mounted on the back of the antenna. This allows cellular operators to purchase the base station antennas and the radios mounted thereon separately, providing greater flexibility to the cellular operators to select antennas and radios that meet operating needs, price constraints and other considerations.

The passive/active antenna system 100 may have a number of advantages over conventional antennas. As cellular operators upgrade their networks to support fifth generation ("5G") service, the base station antennas that are being deployed are becoming increasingly complex. It is desirable to minimize antenna size and/or integrate increased number of antenna or antenna elements inside a single radome. For example, due to space constraints and/or allowable antenna counts on antenna towers of existing base stations, it may not be possible to simply add new antennas to support 5G service. Accordingly, cellular operators are opting to deploy antennas that support multiple generations of cellular service by including linear arrays of radiating elements that operate in a variety of different frequency bands in a single antenna. Thus, for example, it is common now for cellular operators to request a single base station antenna that supports service in three, four or even five or more different frequency bands. Moreover, in order to support 5G service, these antennas may include multi-column arrays of radiating elements that support active beamforming. Cellular operators are seeking to support all of these services in base station antennas that are comparable in size to conventional base station antennas that supported far fewer frequency bands.

The active antenna modules 150 may be readily replaced in the field. As is well known, passive/active antenna systems 100 are typically mounted on towers, often hundreds of feet above the ground. The passive base station antennas 110 may also be large, heavy and mounted on antenna mounts that extend outwardly from the tower. As such, replacing passive base station antennas 110 may be difficult and expensive. The active antenna modules 150 with beamforming radios may be field installable and/or replaceable without the need to detach the passive base station antenna 110 from an antenna mount.

Referring now to FIG. 4, a prior known base station antenna assembly 200 is illustrated. Similar to the base station antenna 10 illustrated in FIG. 1, the base station antenna assembly 200 is typically mounted with the longitudinal axis L of the antenna 10 extending along a vertical axis (e.g., the longitudinal axis L may be generally perpendicular to a plane defined by the horizon) when the assembly 200 is mounted for normal operation. The assembly 200 comprises a base station antenna 210 including a radome 212 and an upper end cap 220. The base station antenna 210 also includes a lower end cap 230 which includes a plurality of connectors 240 mounted therein. As shown in FIG. 4, the base station antenna assembly 200 further includes one or more external sensors 260. For example, U.S. Patent No. 10,396,426, the disclosures of which are hereby incorporated by reference herein, describes a base station antenna having an alignment module with a GPS receiver rigidly mounted onto the antenna. In other instances, the external sensors may each include a photo-cell for sensing ambient light, a microphone and/or other sensors configured to detect sound, an imaging device (e.g., thermal cameras, infrared cameras, still cameras, motion cameras, and so on), a radio frequency identification (RFID) sensor, a moisture sensor, a temperature sensor, and/or a particulate sensor (e.g., a smoke detector, a radiation sensor, a volatile organic compound (VOC) sensor, or the like). It is noted that the listed sensors are merely provided as examples, and the present disclosure is not limited thereto. The number, type, and position of the sensors may be selected based on conditions or characteristics of the vicinity of the installation site of the base station antenna assembly 200. For example, it may be more practical as a matter of early detection and/or warning to place a greater number of radiation sensors (e.g., a greater number of base station antenna assemblies 200 having at least one radiation sensor) near a known radiation source, such as a power plant, and/or near a known or expected site for potential aberrant and/or terrorist activity, such as more densely populated areas and/or central business areas (e.g., downtown). Conversely, some of the sensors may be optional or omitted as local conditions warrant.

In some instances, the external sensor(s) 260 resides in a housing 250 secured to the base station antenna 210, for example, to the upper end cap 220. In other instances, the external sensor(s) 260 may be secured to another section of the base station antenna 210 (e.g., the radome 212 or corresponding mounting structure, see, e.g., FIG. 3A). In addition, one or more cables 265 are coupled to the external sensor(s) 260. The one or more cables 265 provide a communication link and supply power to the external sensor(s) 260. As further shown in FIG. 4, the one or more cables 265 are configured to be routed to the external sensor(s) 260 (and corresponding housing 250) externally from the housing or radome 212 of the base station antenna 210, thereby allowing transmission of the optical (or other) information obtained from the sensor(s) 260.

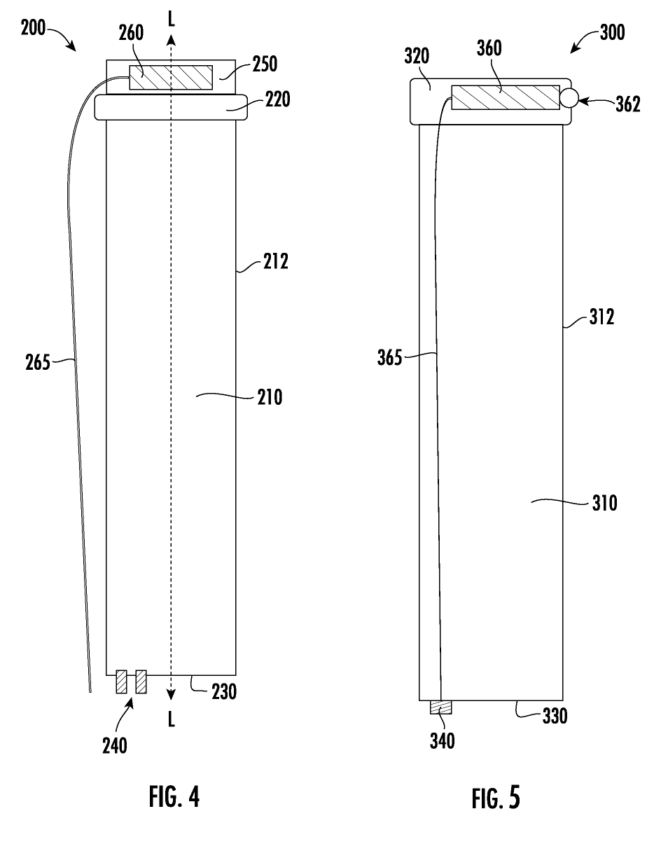

Pursuant to embodiments of the present invention, a base station antenna with an integrated camera is provided. According to embodiments of the present invention, the base station antenna may also include a multi-input-multi-output (mMIMO) beamforming antenna array, thereby allowing joint optical and radio signal processing capabilities. Embodiments of the present invention will now be discussed in greater detail with reference to FIGS. 5-8B.

In the description that follows, the base station antennas of the present invention will be described using terms that assume that the base station antennas are mounted for use on a tower, pole or other mounting structure with the longitudinal axis L of the base station antenna (see, e.g., FIG. 1 and FIG. 4) extending generally along a vertical axis and the front of the base station antenna mounted opposite the tower, pole or other mounting structure pointing toward the target coverage area for the base station antenna and the rear of the base station antenna facing the tower or other mounting structure. It will be appreciated that the base station antennas may not always be mounted so that the longitudinal axis thereof extends along a vertical axis. For example, the base station antennas may be tilted slightly (e.g., less than 10º) with respect to the vertical axis so that the resultant antenna beams formed by the base station antennas each have a small mechanical downtilt or uptilt.

Referring now to FIG. 5, a base station antenna assembly 300 according to embodiments of the present invention is illustrated. Properties and/or features of the base station antenna assembly 300 may be as described above in reference to the base station antenna 10 shown in FIG. 1 and FIG. 2, the passive/active antenna system 100 shown in FIGS. 3A-3C, and/or the base station antenna assembly 200 shown in FIG. 4, and duplicate discussion thereof may be omitted herein for the purposes of discussing FIG. 5.

Similar to the base station antennas described herein, in some embodiments, the base station antenna assembly 300 of the present invention comprises a base station antenna 310 including an external housing 312 (e.g., a radome). In some embodiments, the base station antenna 310 includes a plurality of connectors 340 extending outwardly from the external housing 312. In some embodiments, the base station antenna 310 may include an upper end cap 320. In some embodiments, the base station antenna 310 may include a lower end cap 330 in which the plurality of connectors 340 is mounted therein. As shown in FIG. 5, according to embodiments of the present invention, the base station antenna assembly 300 further includes one or more integrated sensors 360. In some embodiments, the integrated sensors 360 may include a photo-cell for sensing ambient light, a microphone and/or other sensors configured to detect sound, an imaging device (e.g., thermal cameras, infrared cameras, still cameras, motion cameras, and so on), a radio frequency identification (RFID) sensor, a moisture sensor, a temperature sensor, and/or a particulate sensor (e.g., a smoke detector, a radiation sensor, a volatile organic compound (VOC) sensor, or the like). It is noted that the listed sensors are merely provided as examples, and the present disclosure is not limited thereto. The number, type, and position of the integrated sensors 360 may be selected based on conditions or characteristics of the vicinity of the installation site of the base station antenna assembly 300. For example, it may be more practical as a matter of early detection and/or warning to place a greater number of radiation sensors (e.g., a greater number of base station antenna assemblies 300 having at least one radiation sensor) near a known radiation source, such as a power plant, and/or near a known or expected site for potential aberrant and/or terrorist activity, such as more densely populated areas and/or central business areas (e.g., downtown). Conversely, some of the sensors may be optional or omitted as local conditions warrant.

As noted above, in some embodiments, the integrated sensor is an imaging device (e.g., integrated camera 360). As shown in FIG. 5, in some embodiments, the integrated sensor/camera 360 may reside within (inside) the external housing 312 of the base station antenna 310. For example, in some embodiments, the integrated sensor/camera 360 may reside within the upper end cap 320 of the base station antenna 310. In other embodiments, the integrated sensor/camera 360 may reside in a separate housing coupled to the external housing 312 (or the upper end cap 320) of the base station antenna 310. In some embodiments, the upper end cap 320 (or external housing 312) may have any opening 362, for example, to position and focus a lens of the integrated camera 360 (or other integrated sensor) therethrough. As further shown in FIG. 5, in some embodiments, one or more cables 365 connected to the integrated sensor/camera 360 may be routed internally within the base station antenna 310 (i.e., within an internal cavity of the external housing 312). The respective cables 365 may be routed to corresponding connectors 340 extending from a lower end (e.g., a lower end cap 330) of the base station antenna 310, thereby allowing transmission of the optical (or other) information obtained from the integrated sensor/camera 360.

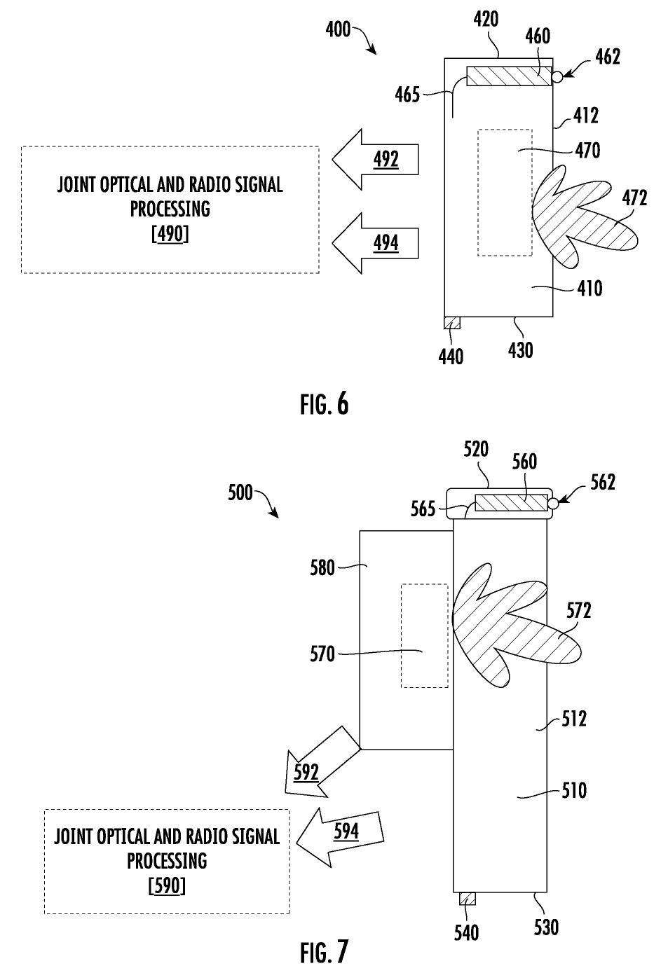

Referring now to FIG. 6, another base station antenna assembly 400 according to embodiments of the present invention is illustrated. Properties and/or features of the base station antenna assembly 400 may be as described above in reference to the base station antenna 10 shown in FIG. 1 and FIG. 2, the passive/active antenna system 100 shown in FIGS. 3A-3C, and/or the base station antenna assemblies 200, 300 shown in FIG. 4 and FIG. 5, and duplicate discussion thereof may be omitted herein for the purposes of discussing FIG. 6.

As shown in FIG. 6, similar to the other base station antennas described herein, in some embodiments, the base station antenna 410 of the base station antenna assembly 400 includes an external housing 412 (e.g., a radome). In some embodiments, the base station antenna 410 may further include an upper end cap 420. In some embodiments, the base station antenna 410 may have a lower end 430 which includes a plurality of connectors 440 extending outwardly therefrom. In other embodiments, the plurality of connectors 440 may extend outwardly from another section (of the housing 312) of the base station antenna 410. The base station antenna assembly 400 differs from the base station antenna assemblies 200, 300 described herein and shown in FIGS. 4-5 in that the base station antenna 410 further includes an active antenna module 470 comprising a multi-input-multi-output (mMIMO) beamforming antenna array (i.e., a mMIMO Active Antenna System with beamforming). Similar to other active antenna modules described therein (see, e.g., FIGS. 3A-3C), the active antenna module 470 of the base station antenna assembly 400 and corresponding mMIMO beamforming antenna array contained therein are capable of electronically adjusting the amplitudes and/or phases of the subcomponents of an RF signal that are output to different radiating elements. For example, the amplitudes and phases of the sub-components of the RF signal that are fed to the radiators in each column of the mMIMO beamforming antenna array (see, e.g., FIG. 3C) may be adjusted so that the generated antenna beam 472 is narrowed in the azimuth plane and pointed in a desired direction in the azimuth plane. In some embodiments, the active antenna module 470 may further include other components such as filters, a calibration network, an antenna interface signal group (AISG) controller and the like.

As further shown in FIG. 6, according to embodiments of the present invention, the base station antenna assembly 400 may also include one or more integrated sensors (or cameras) 460. The integrated sensors 460 may each include a photo-cell for sensing ambient light, a microphone and/or other sensors configured to detect sound, an imaging device (e.g., thermal cameras, infrared cameras, still cameras, motion cameras, and so on), a radio frequency identification (RFID) sensor, a moisture sensor, a temperature sensor, and/or a particulate sensor (e.g., a smoke detector, a radiation sensor, a volatile organic compound (VOC) sensor, or the like). It is noted that the listed sensors are merely provided as examples, and the present disclosure is not limited thereto. The number, type, and position of the sensors may be selected based on conditions or characteristics of the vicinity of the installation site of the base station antenna assembly 400.

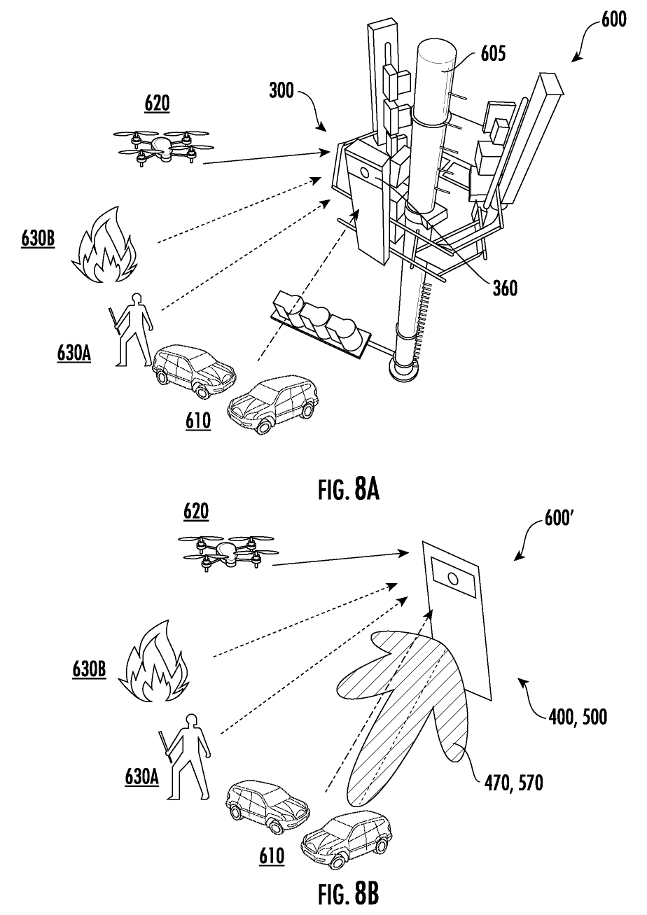

As noted above, in some embodiments, the integrated sensor 460 is an imaging device (i.e., camera). In some embodiments, for example, when the integrated sensor 460 is an imaging device, the base station antenna assembly 400 is configured to provide joint optical 494 and radio signal 492 processing of information (see, e.g., Block 490). In other words, in some embodiments, the base station antenna assembly 400 is configured to generate an antenna beam 472 (e.g., via the mMIMO beamforming antenna array) based on optical information (e.g., still images or videos) of the corresponding coverage area taken and transmitted by the integrated sensor/camera 460 (see also, e.g., FIG. 8B).

As shown in FIG. 6, in some embodiments, the integrated sensor/camera 460 may reside within the external housing 412 of the base station antenna 410. In other embodiments, the integrated sensor/camera 460 may reside in the upper end cap 420 or separate housing coupled to the external housing 412 of the base station antenna 410. In some embodiments, the base station antenna 410 may have any opening 462, for example, in the external housing 412 or other housing, which provides a location to position and focus a lens of the integrated sensor/camera 460 therethrough. As further shown in FIG. 6, in some embodiments, one or more cables 465 connected to the integrated sensor/camera 460 may be routed internally within the base station antenna 410 (i.e., within an internal cavity of the external housing 412 or antenna housing). In some embodiments, the respective cables 465 may be routed to corresponding connectors 440 of the base station antenna 410, thereby allowing transmission of the optical (or other) information obtained from the integrated sensor/camera 460. As noted above, this information may then be used to adjust the antenna beams 472 (via the mMIMO beamforming antenna array) to a targeted area within the sector (e.g., narrow the antenna beam 472 in the azimuth plane and pointed in a desired direction in the azimuth plane) (see also, e.g., FIG. 8B).

Referring now to FIG. 7, another base station antenna assembly 500 according to embodiments of the present invention is illustrated. Properties and/or features of the base station antenna assembly 500 may be as described above in reference to the base station antenna 10 shown in FIG. 1 and FIG. 2, the passive/active antenna system 100 shown in FIGS. 3A-3C, and/or the base station antenna assemblies 200, 300, 400 shown in FIGS. 4-6, and duplicate discussion thereof may be omitted herein for the purposes of discussing FIG. 7.

As shown in FIG. 7, similar to the passive/active antenna system 100 described herein and shown in FIGS. 3A-3C, in some embodiments, the base station antenna assembly 500 comprises a includes passive base station antenna 510 and an active antenna module 580. Similar to other base station antennas described herein, in some embodiments, the passive base station antenna 510 of the base station antenna assembly 500 includes an external housing 512. In some embodiments, the base station antenna 510 may also include an upper end cap 520. In some embodiments, the base station antenna 510 includes a plurality of connectors 540 extending outwardly from the external housing 512. In some embodiments, the passive base station antenna 510 may include a lower end cap 530 in which the plurality of connectors 540 are mounted therein. As further shown in FIG. 7, in some embodiments, the active antenna module 580 may be coupled to a rear surface of the passive base station antenna 510. The active antenna module 580 comprises a multi-input-multi-output (mMIMO) beamforming antenna array 570 which is capable of electronically adjusting the amplitudes and/or phases of the subcomponents of an RF signal that are output to different radiating elements (i.e., a mMIMO Active Antenna System with beamforming). For example, the amplitudes and phases of the sub-components of the RF signal that are fed to the radiators in each column of the mMIMO beamforming antenna array (see, e.g., FIG. 3C) may be adjusted so that the generated antenna beam 572 is narrowed in the azimuth plane and pointed in a desired direction in the azimuth plane. In some embodiments, the active antenna module 570 may further include other components such as filters, a calibration network, an antenna interface signal group (AISG) controller and the like.

According to embodiments of the present invention, the base station antenna assembly 500 may also include one or more integrated sensors (or cameras) 560. The integrated sensors 560 may each include a photo-cell for sensing ambient light, a microphone and/or other sensors configured to detect sound, an imaging device (e.g., thermal cameras, infrared cameras, still cameras, motion cameras, and so on), a radio frequency identification (RFID) sensor, a moisture sensor, a temperature sensor, and/or a particulate sensor (e.g., a smoke detector, a radiation sensor, a volatile organic compound (VOC) sensor, or the like). It is noted that the listed sensors are merely provided as examples, and the present disclosure is not limited thereto. The number, type, and position of the sensors may be selected based on conditions or characteristics of the vicinity of the installation site of the base station antenna assembly 500.

As noted above, in some embodiments, the integrated sensor 560 is an imaging device (i.e., camera). In some embodiments, for example, when the integrated sensor/camera 560 is an imaging device, the base station antenna assembly 500 is configured to provide joint optical 594 and radio signal 592 processing of information (see, e.g., Block 590). In other words, in some embodiments, the base station antenna assembly 500 is configured to generate an antenna beam 572 (e.g., via the mMIMO beamforming antenna array) based on optical information (e.g., still images or videos) of the corresponding coverage area taken and transmitted by the integrated sensor/camera 560 (see also, e.g., FIG. 8B).

As shown in FIG. 7, in some embodiments, the integrated sensor/camera 560 may reside within the external housing 512 (or upper end cap 520) of the passive base station antenna 510. In other embodiments, the integrated sensor/camera 560 may reside in a separate housing coupled to the external housing 512 of the base station antenna 510. In some embodiments, the housing 512 or the upper end cap 520 of the passive base station antenna 510 may have any opening 562, for example, which provides a location to position and focus a lens of the integrated sensor/camera 560 therethrough. As further shown in FIG. 7, in some embodiments, one or more cables 565 connected to the integrated sensor/camera 560 may be routed internally within the passive base station antenna 510 (i.e., within an internal cavity of the external housing 512). The respective cables 565 may be routed to corresponding connectors 540, for example, extending from the lower end cap 530 of the base station antenna 510, thereby allowing transmission of the optical (or other) information obtained from the integrated sensor/camera 560. As noted above, this information may then be used to adjust the antenna beams 572 (via the mMIMO beamforming antenna array) to a targeted area within the sector (e.g., narrow the antenna beam 572 in the azimuth plane and pointed in a desired direction in the azimuth plane) (see also, e.g., FIG. 8B).

As described herein, the base station antenna assemblies 300, 400, 500 of the present invention include one integrated sensors (e.g., cameras) 360, 460, 560 which may be used for a number of different applications. FIGS. 8A-8B illustrate example applications 600, 600' for which the base station antenna assemblies 300, 400, 500 shown in FIG. 6 and FIG. 7 may be used. As shown in FIGS. 8A-8B, in some embodiments, the base station antenna assemblies 300, 400, 500 may be used for traffic control (610), drone detection (620), and/or remote sensing and security (630A, 630B). Note that these applications are examples, and the present invention is not limited thereto. As shown in FIG. 8A, in some embodiments, the base station antenna assembly 300 (i.e., a base station antenna with one or more integrated sensors/cameras 360) may be used. As shown in FIG. 8B, in some embodiments, the base station antenna assemblies 400, 500 (i.e., a base station antenna having an mMIMO beamforming antenna array and one or more integrated sensors/cameras 460, 560). The base station antenna assemblies 300, 400, 500 may be mounted on a structure such as a mounting pole 605. The base station antenna assemblies 300, 400, 500 of the present invention provide a number of advantages, including, but not limited to, the integrated sensors being non-visible, protected, having a constant power supply, and positioned to have a good field of view. The base station antenna assemblies 400, 500 provide the additional advantage using information from the integrated sensors (e.g., camera picture) and radio signals to position and adjust an antenna beam via the mMIMO beamforming antenna array, for example, using beam selection or direction of arrival (DoA) estimation.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A base station antenna assembly, the base station antenna assembly comprising:
a base station antenna comprising an external housing having a plurality of connectors extending outwardly therefrom; and
one or more integrated sensors residing inside of the external housing of the base station antenna,
wherein each of the integrated sensors are coupled to a respective connector of the plurality of connectors via one or more cables, the one or more cables being routed inside of the external housing of the base station antenna.

2. The base station antenna assembly according to claim 1, wherein the one or more integrated sensors comprise at least one of: a photo-cell for sensing ambient light, a microphone and/or other sensors configured to detect sound, an imaging device, a radio frequency identification (RFID) sensor, a moisture sensor, a radiation sensor, a temperature sensor, and a particulate sensor.

3. The base station antenna assembly according to claim 2, wherein the imaging device is a thermal camera, an infrared camera, a still camera, or a motion camera.

4. The base station antenna assembly according to claim 2, wherein the particulate sensor is a smoke detector, a radiation sensor, or a volatile organic compound (VOC) sensor.

5. The base station antenna assembly according to claim 1, wherein the one or more integrated sensors reside within the upper end cap of the base station antenna.

6. The base station antenna assembly according to claim 1, wherein the one or more integrated sensors reside within a separate housing coupled to the external housing of the base station antenna.

7. The base station antenna assembly according to claim 1, wherein the external housing of the base station antenna comprises an opening configured to position at least a portion of the one or more integrated sensors.

8. The base station antenna assembly according to claim 1, further comprising a multi-input-multi-output (mMIMO) beamforming antenna array.

9. A base station antenna assembly, the base station antenna assembly comprising:
a base station antenna comprising an external housing;
an active antenna module comprising a multi-input-multi-output (mMIMO) beamforming antenna array; and
one or more integrated sensors residing inside of the external housing of the base station antenna, wherein at least one of the integrated sensors is an imaging device.

10. The base station antenna assembly according to claim 9, wherein the base station antenna assembly is configured to generate and adjust an antenna beam in a coverage area based on optical information transmitted by the imaging device.

11. The base station antenna assembly according to claim 9, wherein the base station antenna assembly is configured to provide information in a coverage area base on optical information transmitted by the imaging device.

12. The base station antenna assembly according to claim 9, further comprising a plurality of connectors extending outwardly from the external housing of the base station antenna, each of the integrated sensors are coupled to a respective connector of the plurality of connectors via one or more cables, and the one or more cables are routed inside of the external housing of the base station antenna.

13. The base station antenna assembly according to claim 9, wherein the imaging device is a thermal camera, an infrared camera, a still camera, or a motion camera.

14. The base station antenna assembly according to claim 9, wherein the one or more integrated sensors further comprise a photo-cell for sensing ambient light, a microphone and/or other sensors configured to detect sound, a radio frequency identification (RFID) sensor, a moisture sensor, a radiation sensor, a temperature sensor, and/or a particulate sensor.

15. The base station antenna assembly according to claim 9, wherein the one or more integrated sensors reside within the upper end cap of the base station antenna.

16. The base station antenna assembly according to claim 9, wherein the one or more integrated sensors reside within a separate housing coupled to the upper end cap or the radome of the base station antenna.

17. The base station antenna assembly according to claim 9, wherein the external housing of the base station antenna comprises an opening configured to position at least a portion of the one or more integrated sensors.

18. A base station antenna assembly, the base station antenna assembly comprising:
a passive/active antenna system, the passive/active antenna system comprising:
a passive base station antenna comprising an external housing; and
an active antenna module comprising a multi-input-multi-output (mMIMO) beamforming antenna array; and
one or more integrated sensors residing inside of the external housing of the passive base station antenna, wherein at least one of the integrated sensors is an imaging device.

19. The base station antenna assembly according to claim 18, wherein the base station antenna assembly is configured to generate and adjust an antenna beam in a coverage area based on optical information transmitted by the imaging device.

20. The base station antenna assembly according to claim 18, wherein the base station antenna assembly is configured to provide information in a coverage area base on optical information transmitted by the imaging device.

21. The base station antenna assembly according to claim 18, wherein passive base station antenna comprises a plurality of connectors, each of the integrated sensors are coupled to a respective connector of the plurality of connectors via one or more cables, and the one or more cables are routed inside of the external housing of the passive base station antenna.

22. The base station antenna assembly according to claim 18, wherein the imaging device is a thermal camera, an infrared camera, a still camera, or a motion camera.

23. The base station antenna assembly according to claim 18, wherein the one or more integrated sensors further comprise a photo-cell for sensing ambient light, a microphone and/or other sensors configured to detect sound, a radio frequency identification (RFID) sensor, a moisture sensor, a radiation sensor, a temperature sensor, and/or a particulate sensor.

24. The base station antenna assembly according to claim 18, wherein the one or more integrated sensors reside within the external housing of the passive base station antenna or within a separate housing coupled to the external housing of the passive base station antenna.
